(19) United States
(12) Patent Application Publication
(10) Pub. No.: US 2004/0183717 A1
(43) Pub. Date: Sep. 23, 2004

(54) Cosmic background radiation abnomality detector

(76) Inventor: Joseph Gerard Conley, Baltimore, MD (US)

Correspondence Address: Joseph G. Conley, 3201 Rose Kemp Ave., Baltimore, MD, 21214, US

(21) Appl. No.: 10/388,537

(22) Filed: Mar. 17, 2003

(51) Int. Cl. G01S 13/00

(52) U.S. Cl. 342/90; 342/13

(57) ABSTRACT

cosmic background radiation from the big bang is spread across the entire sky.when a stealth aircraft flies through it, it blocks out the radiation. this makes a moving hole in the radiation.with the proper-receiving equipment, it is posible to detect, track, and target an aircraft.

### BACKGROUND OF THE INVENTION

in normal radar microwaves are sent out and bounced off objects these reflected signals are detected and displayed on various types of displays.

in this system it is the missing radiation that is detected and displayed; this makes-up the signal that is to be processed.

### BRIEF SUMMARY OF THE INVENTION

the discovery that the missing cosmic background radiation indicates that something has come between the source and the detector.

### DETAILED DESCRIPTION OF THE INVENTION

it would be at least two seperate sites, for the equipment they would be seperated by about 5 to 25 miles.

each site would need two types of receives. one would be a plan position type detector for the bearing.

and one would be a height finder type to give the angle to the horizon.

the detector could be a standard microwave amplifier.

the detector would be tuned to the bandwith of the cosmic background radiation.

a voltage drop in the detector will indicate a blockage to the radiation source.

the two sites then give the data to the computer, the computer can then give the range, speed, altitude, and bearing of the aircraft.

with the use of current aircraft detection radars it is possable to incorporate this new system.

1. claim that this system can be used to detect any object that comes between the background source and the detection equipment
i claim that this system could be used to detect, track, target, aircraft, stealth aircraft, satellites, missiles, asteroids, comets.
